(19) United States
(12) Patent Application Publication
(10) Pub. No.: US 2018/0264518 A1
(43) Pub. Date: Sep. 20, 2018

(54) SYSTEM AND METHOD FOR PIPELINE COATING

(71) Applicant: Elite Pipeline Services, Inc., Allendale, MI (US)

(72) Inventors: James W. Shrode, Ft Myers Beach, FL (US); James R. Ball, Grand Rapids, MI (US); Carl R. Beitner, Ada, MI (US); Terry L. Bell, Greenwood, IN (US)

(21) Appl. No.: 15/914,043

(22) Filed: Mar. 7, 2018

Related U.S. Application Data
(60) Provisional application No. 62/471,606, filed on Mar. 15, 2017.

(51) Int. Cl. B05D 7/22; B05D 3/06; B05D 5/00; B05C 7/08; B05C 21/00; F16L 55/1645

(52) U.S. Cl. CPC B05D 7/222; B05D 3/067; F16L 55/1645; B05C 7/08; B05C 21/00; B05D 5/005

(57) ABSTRACT

A coating system to coat the interior of a pipeline section using a UV curable coating and an internally pressurized UV foil that assists in suspending and distributing coatings during UV curing. The UV foil may be installed through the length of the pipeline section using an inversion system driven by pressurized air. The system includes a coating delivery system for distributing the coating along the interior of the pipe. The system includes a UV light source capable of delivery sufficient UV light to cure the coating. The UV light source may include a light train having a plurality of UV light sources, such as UV light emitting diodes, carried by a motorized trolley. The coating system includes an inlet adapter that facilitates inversion and pressurization of the UV foil, as well as introduction of the UV light source into the interior of the pressurized UV foil.

### BACKGROUND OF THE INVENTION

The present invention relates to pipeline coating and more particularly to systems and methods for internal coating of installed pipeline while the pipeline remains installed.

Pipeline coating is often paramount when maintaining a system for operation. While repairs options can be abundant, or limited depending on pipeline size, application and timing, epoxy coatings have been used for years, both internally and externally, as means for remediation. Typical coatings consist of a two-part component that is mixed, placed and often ambient cured. Curing can be accelerated in a variety of ways, but is typically not controllable.

There has been some use of UV curable epoxy in pipeline rehabilitation. However, known technologies using UV based epoxy for pipeline rehabilitation are typically associated with cure-in-place pipe (“CIPP”) relining. These technologies conventionally use a felt or fiberglass impregnated tube as a carrier that is used to renew structurally compromised pipelines—predominantly storm and sewer applications. The resin/felt matrix together provides structural strengthening and renewal. Liners associated with CIPP relining are pulled-in-place using mechanical winches, inflated and cured to provide a PIPE WITHIN A PIPE. Most CIPP installations have significant ID reduction, do not bond to the host pipe and have limitations related to pipeline configuration, fittings and lengths. This technology in concept or delivery does not correlate to many markets, purposes, industries or applications.

### SUMMARY OF THE INVENTION

The present invention provides a coating system for internally coating a section of pipeline using a UV curable coating. The coating system includes UV foil that assists in suspending and distributing coatings over the interior surface of the pipeline section prior to and during UV curing. The UV foil may be installed through the full length of the pipeline section to receive the coating. The UV foil may be installed using an inversion system that drives the UV foil into pipeline using a pressurized fluid, such as pressurized air. The coating system includes a pressure system, such as a source of compressed air, for internally pressurizing the UV foil. A single pressure system may be provided to invert and internally pressurize the UV foil.

In one embodiment, the coating system includes a coating delivery system for distributing the coating along the interior of the pipe. In one embodiment, the coating delivery system may be a spin-cast coating delivery system that moves through the pipe and distributes the coating as it travels. In some applications, movement of the spin-cast coating delivery system through the pipeline section may be automated. In other applications, movement may be manual.

In one embodiment, the coating system also includes a vacuum system for applying a vacuum inside the pipeline section external to the UV foil. The vacuum system may be situated downstream from the UV foil insertion location.

In one embodiment, the coating system includes a UV light source capable of delivery sufficient UV light to cure the coating. In one embodiment, the UV light source includes a light train having a plurality of UV light sources, such as UV light emitting diodes, carried by a motorized trolley.

In one embodiment, the coating system includes a camera system. The camera system may be integrated into the light train trolley or may be provided separate from the trolley. The camera system may include a camera that is carried ahead of the light source to allow visual inspection of the pipeline section prior to curing. The camera may be coupled to a display that is located where it is readily visible to an operator.

In one embodiment, the system includes an inlet adapter that facilitates inversion and pressurization of the UV foil, as well as introduction of the UV light source into the interior of the pressurized UV foil. The inlet adapter may be secured to the upstream end of the pipeline section, for example, using a compression fitting. The inlet adapter may be a double-cylinder inlet adapter having a first cylinder for introducing the UV foil into the pipeline section and a second cylinder for introducing a light source into the UV foil.

In one embodiment, the system includes a termination cap configured to be fitted to the downstream end of the pipeline section. The termination cap may be secured to the downstream end of the pipeline section, for example, using a compression fitting. The coating system may be introduced into the interior of the pipeline section through the termination cap. The termination cap may include an air/vacuum inlet, which allows a vacuum to be drawing within the pipeline section.

In another aspect, the present invention provides a method for coating a pipeline section including the general steps of applying a UV-curable coating to the interior of a pipeline section; installing a UV foil inside the pipeline section; internally pressurizing the interior of the UV foil to urge the UV foil into contact with the interior wall of the pipeline section with sufficient force to assist in distribution and retaining the coating in an even layer; subjecting the coating to UV light applied by a UV light train configured to travel through the interior of the pipeline section while the UV foil remains under internal pressure and removing the UV foil.

In one embodiment, the method includes the steps of fitting the open end of the UV foil over the upstream end of the host pipe and installing the inlet adapter over the open end of the UV foil and the upstream end of the host pipe. In this embodiment, the inlet adapter retains the open end of the UV foil over the upstream end of the host pipe in such a way as to allow the UV light train and/or camera to be introduced into the pressurized interior of the UV foil.

In one embodiment, the method includes the step of inverting the UV foil into the pipeline section, pressurizing the interior of the UV foil via the inversion system, closing the gate valve on the UV foil inversion tube, opening the gate valve on the main tube before or after pressurizing the interior of the UV foil and maintaining pressure in the interior of the UV foil via the main tube.

In one embodiment, the method includes the step of closing the gate valve in the main tube, opening the main tube access cap, introducing a light train or camera into the interior of the main tube, opening the gate valve in the main tube and introducing the light train or camera into the interior of the UV foil.

In one embodiment, the method may include the step of inspecting the pipeline section using a camera system configured to travel through the interior of the pipeline section. The camera may be carried on a trolley and may provide video to a display located near an operator. The camera system may be used to inspect the interior of the pipeline section at various times during the coating process. More specifically, the camera system may be used to inspect the interior of the pipeline prior to or after essentially any step in the method.

In one embodiment, the method may include the step of preparing the pipeline section for coating using a preconditioning head configured to travel through the interior of the pipeline section. The preconditioning head may be a pipeline pig configured to scape, brush or otherwise condition the interior surface of the pipe. The preconditioning head may have active elements configured to mechanically abrade or otherwise condition the interior surface of the pipeline, for example, high pressure fluid, sandblasting, wire brushes or other abrasive mechanisms.

In one embodiment, the method may include the step of applying a vacuum to the downstream end of the pipeline section to assist in removing voids and uniformly distributing the coating. The vacuum may be introduced through a termination cap that is position downstream from the UV foil.

The present invention provides a highly reliable system and method for applying coating to pipeline sections. The use of UV-curable coatings allows controlled curing of the coatings, which in turn provides a finished coating of significantly higher quality and consistency. The UV foil helps to provide and maintain uniform distribution of the coating before and during curing. The use of an external vacuum can provide a number of benefits. For example, the vacuum may help to invert and draw the UV foil into proper position within the pipeline section. Further, the vacuum may assist in removing air pockets trapped between the UV foil and the coating, thereby improving quality and uniformity of the coating. The inlet adapter provides a simple and effective structure for introducing the UV foil and light train into the pipeline section and for maintaining pressure in the interior of the UV foil. The outlet adapter provide a simple and effective structure for closing the downstream end of the pipeline section in such a way as to allow introduction of a coating delivery system and application of a partial vacuum.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is a perspective view of a pipeline section incorporating an inlet adapter and termination cap in accordance with an embodiment of the present invention.

FIG. 2 is a perspective view of the inlet adapter.

FIG. 3 is a sectional view of a portion of the pipeline section.

FIG. 4 is a perspective view of the termination cap.

FIG. 5 is a partially exploded perspective view of a portion of the coating system situated toward the upstream end of the pipeline section.

FIG. 6 is a sectional view of a portion of the inlet adapter showing the secondary access cap.

FIG. 7 is an illustration of the coating system assembled on the pipeline section showing the UV light source disposed inside the inlet adapter.

FIG. 8 is an alternative termination cap.

FIG. 9 is a representative schematic diagram of the coating system.

### DESCRIPTION OF THE CURRENT EMBODIMENT

A. Overview

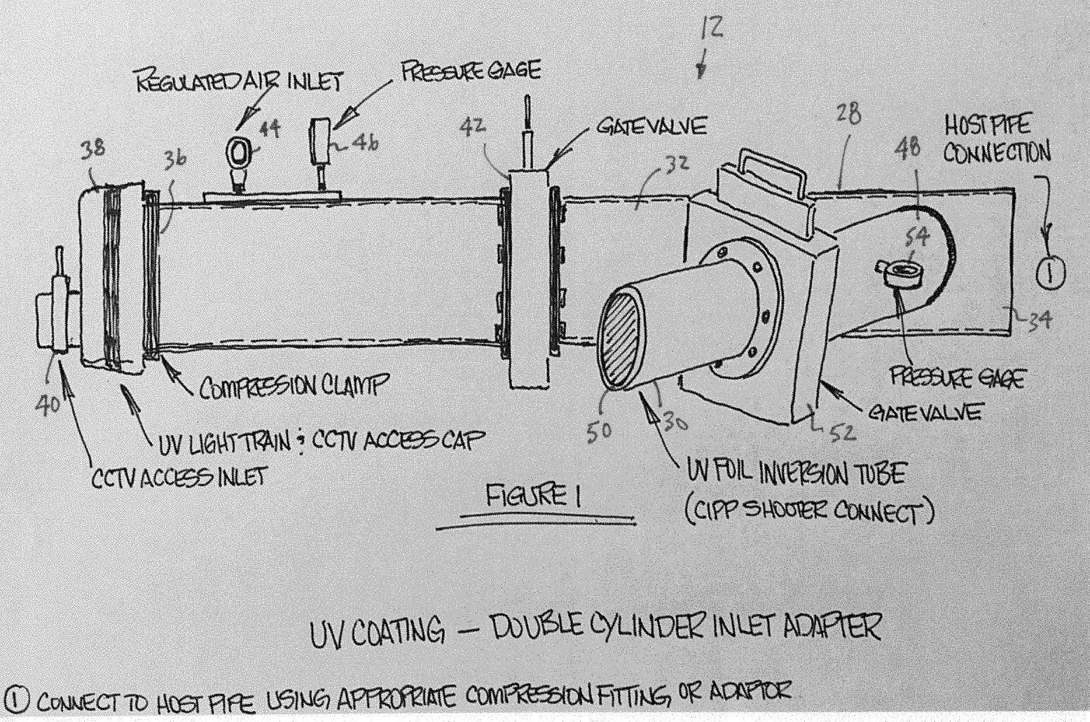

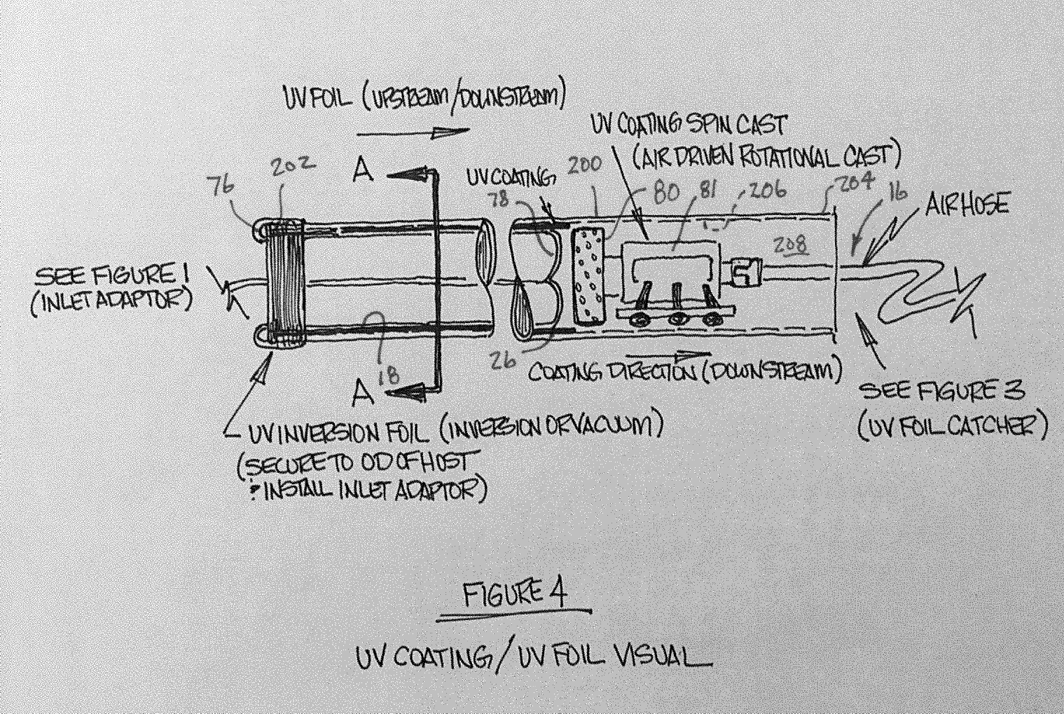

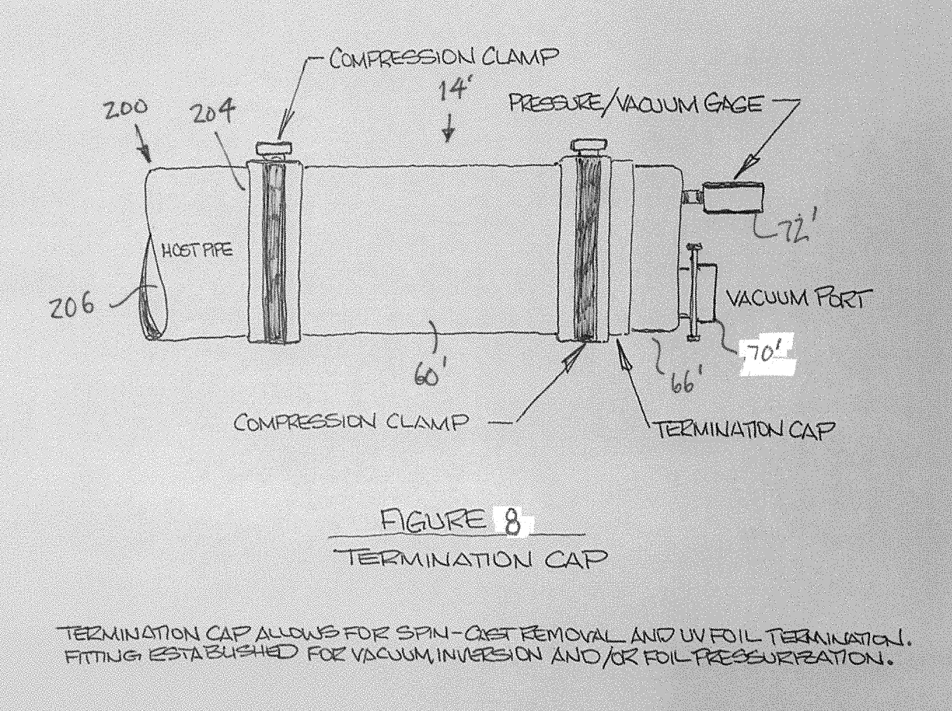

The present invention is directed to a system and method for coating the interior of pipeline sections. In the illustrated embodiment, the coating system 10 generally includes an inlet adapter 12, a termination cap 14, a coating delivery system 16, a UV foil 18, a foil inversion system 20 and a UV light source 22 (See FIGS. 4 and 7). The coating system 10 may also include a camera system 24 to facilitate visual inspection of the interior of the pipeline section. FIG. 1 is an illustration of a pipeline section 200 fitted with an inlet adapter 12 and a termination cap 14 in accordance with an embodiment of a coating system 10 of the present invention. During use of the illustrated embodiment, a coating 26 is applied to the interior of the pipeline section 10 using the coating deliver system 16. The coating delivery system 16 may be introduced into the pipeline section 200 via the termination cap 14. A UV foil 18 is then introduced into the interior of the pipeline section 200 via a UV foil inversion tube 30 integrated into the inlet adapter 12. The UV foil 18 is internally pressurized to urge the UV foil 18 outwardly into contact with the uncured coating 26. The pressure is sufficient for the UV foil 18 to assist in distributing and retaining the coating 26 in a uniform layer over the interior of the pipeline section 200. The UV light source 22 is then introduced into the interior of the pipeline section 200 and moved through the interior of the UV foil 18 along the length of the pipeline section 200 to cure the coating 26. The UV light source 22 may be introduced into the pipeline section 200 via the inlet adapter 12.

For purposes of disclosure, the terms “upstream” and “downstream” are used as relative terms to describe directions relative to the longitudinal length of the pipeline section. The term “upstream” relates to a direction toward the end of the pipeline section through which the UV foil is introduced into the pipeline section and the term “downstream” refers to a direction toward the opposite end of the pipeline section. These terms are used without reference to the direction through which fluid passes through the pipeline during normal use. Further, directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

B. Coating System

The present invention is described and illustrated in the context of an exemplary pipeline section. The present invention may be used in a wide variety of pipeline sections of different sizes and shapes. For example, the inlet adapter, termination cap and UV foil may be scaled to accommodate the inner and outer diameters of the pipeline section to be coated. Similarly, the coating delivery system and UV light source may be integrated into carriers that are appropriate for the applicable pipeline section. In some applications, these components may be carried by trollies or pigs configured for use pipeline sections of the corresponding internal diameter. Although the illustrated pipeline section is straight, the present invention may be implemented in pipeline sections that are not straight. In pipeline sections with significant curves or bends, it may be desirable to make accommodations in the components that travel through the interior of the pipeline section to facilitate navigation through such curves or bends.

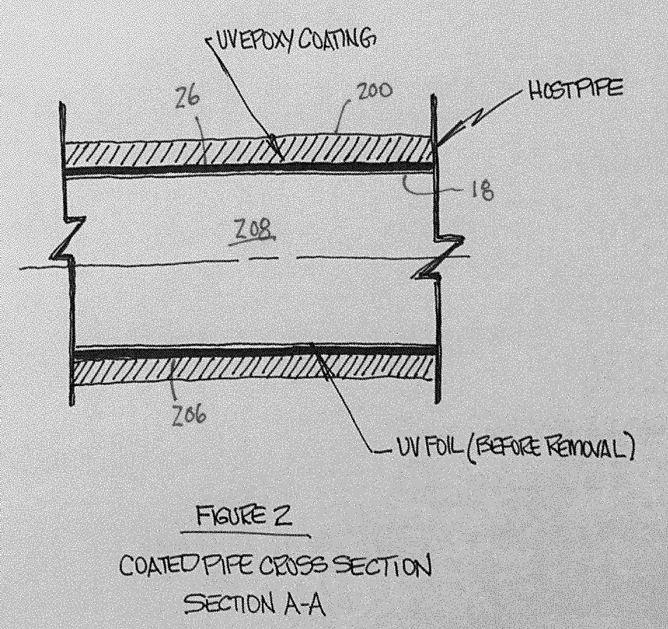

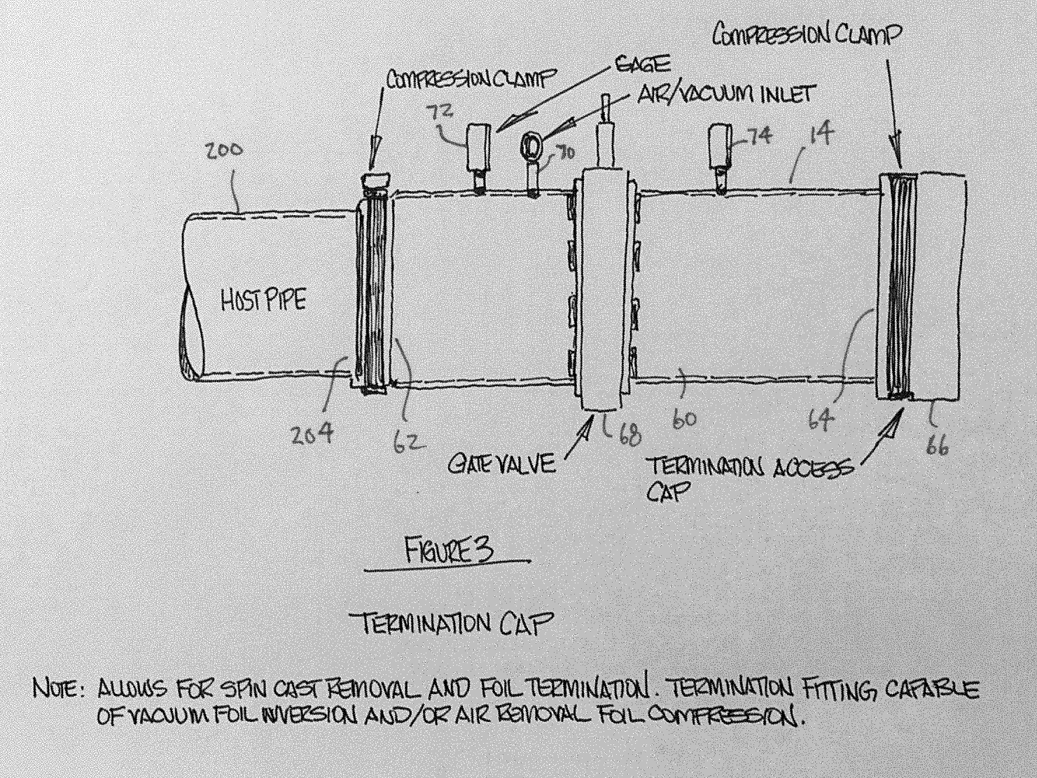

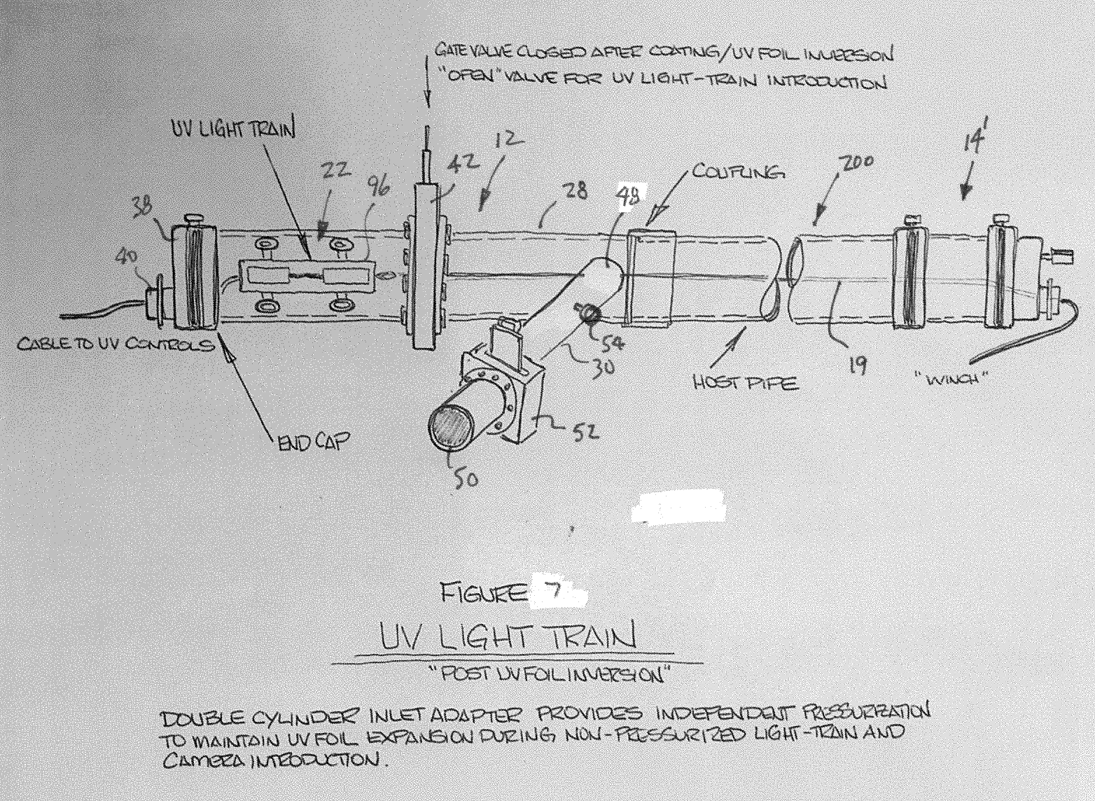

The coating system 10 of FIGS. 1-6 generally includes an inlet adapter 12, a termination cap 14, a coating delivery system 16, a UV foil 18, a foil inversion system 20 and a UV light source 22. The coating system 10 may also include a camera system 24 to facilitate visual inspection of the interior of the pipeline section 200. In some embodiments, the coating system 10 may further include a vacuum system 94 to draw a partial vacuum within the interior of the pipeline section 200.

FIG. 1 is an illustration of a pipeline section 200 fitted with an inlet adapter 12 and a termination cap 14 in accordance with an embodiment of a coating system 10 of the present invention. The pipeline section 200 has an upstream end 202, a downstream end 204 and an interior surface 206 that defines a pipeline section interior 208. The illustrated pipeline section 200 is merely exemplary and the present invention may be used to apply coatings to a wide range of pipeline sections of different sizes and shapes. The illustrated embodiment shows a straight pipeline section of uniform inner and outer diameters. The present invention may be used to apply coatings to pipeline sections that are not straight and that have variations in inner and/or outer diameter.

The inlet adapter 12 is generally configured to close off the upstream end 202 of the pipeline section 200 and to allow selective introduction of the UV foil 18 and the UV light source 22 into the interior of the pipeline section 200. The inlet adapter 12 may also allow introduction of a camera into the interior of the pipeline section 200. The inlet adapter 12 of the illustrated embodiment generally includes a main tube 28 and a UV foil inversion tube 30. In this embodiment, the main tube 28 generally corresponds with the diameter of the host pipe (pipeline section 200). The main tube 28 generally includes a cylinder 32 having a mounted end 34 secured to pipeline section 200 and a free end 36 that is opposite the mounted end 34, a primary access cap 38 closing the free end 36 of the cylinder 32, a secondary access cap 40 disposed within the primary access cap 38, a gate valve 42 and an air inlet 44. The main tube 28 may also include a pressure gauge 46. The free end 36 of the cylinder 32 is connected to the upstream end of the pipeline section 200, for example, by a compression fitting, adaptor or other similar component. The gate valve 42 is situated toward the longitudinal center of the cylinder 32 and is configured to selectively isolate an upstream segment of the cylinder 32 from a downstream segment of the cylinder 32. In the illustrated embodiment, the position of the gate valve 42 is selected so that the upstream segment of the cylinder 32 is of sufficient length to accommodate the UV light source 22 and/or the camera of camera system 24. The position of the gate valve 42 may vary from application to application as desired. The gate valve 42 may be replaced by other types of valves. In this embodiment, the air inlet 44 and pressure gauge 46 are disposed in the upstream segment of the cylinder 32. The air inlet 44 may be coupled to a supply of pressurized air, such as compressor 98.

The UV foil inversion tube 30 intersects with the main tube 28 upstream from the mounted end 34 of the cylinder 32. The UV foil inversion tube 30 generally include a fixed end 48 joined to the main tube 28 and a free end 50 opposite the fixed end 48. A gate valve 52 is situated in the UV foil inversion tube 30. The position of the gate valve 52 in the UV foil inversion tube 30 may vary. The gate valve 52 may be replaced by other types of valves. The UV foil inversion tube 32 may also include a pressure gauge 54 to assist during operation. The free end 50 of the UV foil inversion tube 30 is configured to be operatively coupled to the UV foil inversion system 20. As described in more detail below, the UV foil inversion system 20 may be a conventional cast in place pipeline (“CIPP”) air inversion system.

The termination cap 14 is configured to mount the downstream end of the pipeline section 200. Generally speaking, the termination cap 14 is configured to close the downstream end of the pipeline section 200 while facilitating introduction of the coating delivery system 16. In some applications, the termination cap 14 may be configured to also allow removal of the UV foil and/or the application of a downstream vacuum to the interior of the pipeline section 200. The termination cap 14 generally includes a main tube 60 having a mounted end 62 affixed to the pipeline section and a free end 64 opposite the mounted end 62, a termination access cap 66 and a gate valve 68. The mounted end 62 of the termination cap 14 may be mounted to the downstream end of the pipeline section 200 by a compression clamp, adaptor or other similar component capable of providing a leaktight connection. The gate valve 68 may be replaced by other types of valves. In applications where it is desirable to introduce a partial vacuum to the downstream end of the pipeline section 200, the termination cap 14 may also include an air/vacuum inlet 70. A pair of pressure gauges 72 and 74 may also be provided on opposite sides of gate valve 68.

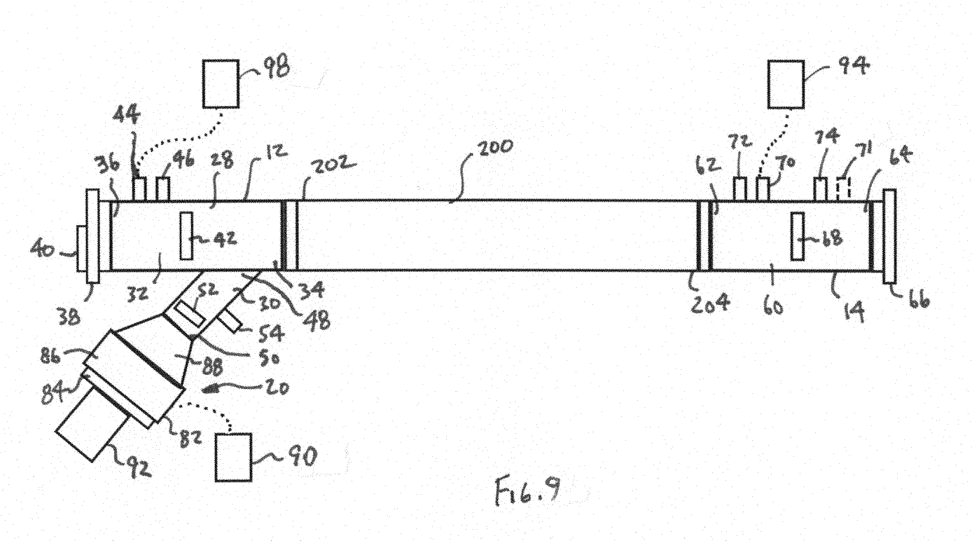

The design and configuration of the termination cap may vary from application to application. For example, an alternative termination cap 14′ is shown in FIGS. 7 and 8. In this embodiment, the termination cap 14′ includes a cylinder 60′ that is closed by an access cap 66′. The access cap 66′ of this embodiment includes an inlet port 70′ through which a vacuum can be drawn in the downstream end of the pipeline section 200. For example, the vacuum port 70′ may be coupled to a vacuum source. Additionally, the inlet port 70′ may provide an opening through which accessories may be fed into the interior of the pipeline section 200. For example, supply lines associated with the coating delivery system and/or winch cables associated with a trolley (e.g. a camera trolley and/or a UV light source trolley) may be fed into the pipeline section 200 through the inlet port 70′. A pressure gauge 72′ may also be included to assist in maintain the proper pressure in the downstream end of the pipeline section 200.

The UV foil 18 is a flexible tubular structure that is of sufficient length to extend through the full length of the pipeline section 200. To facilitate inversion, the UV foil 18 includes an open end 76 and a closed end 78. The closed end 78 of the UV foil 18 may be closed by rolling and clamping or any other suitable method. During assembly, the open end 76 is fitted over the host pipe (pipeline section 200) and secured by installation of the inlet adapter 12. The remainder of the UV foil 18, including the closed end 78, is coiled in the inversion system. Pressurized air is used to invert the UV foil 18 and move it through the pipeline section 200. Once fully installed, the UV foil 18 will be fully inverted and the closed end 78 will be situated at the downstream end of the pipeline section 200, for example, in termination cap 14. The UV foil 18 may be manufactured from a wide range of alternative materials, such as clear plastic, latex, nitrile, neoprene or equivalent material. The UV foil 18 material should be sufficiently transparent to UV light to allow the light from the light source to pass through the UV foil 18 to cure the coating 26, and should have the strength to withstand the pressure boundaries associated with the coating process. For example, the UV foil 18 should be capable of withstanding inversion and internal pressurization pressures between 3-10 psi. This pressure range is merely exemplary and pressures outside this range may be used in alternative applications. For example, higher pressures may be used in smaller diameter pipeline sections or when additional pressure is useful in distributing or suspending the coating 26. The amount of elasticity in the UV foil may vary from application to application. In some applications, the UV foil 18 may be essentially inelastic in response to the anticipated internal pressure. However, the UV foil 18 may be manufactured from an elastic material that undergoes significant expansion as the UV foil 18 undergoes internal pressurization. In the illustrated embodiment, the UV foil 18 is configured to be removed from the pipeline section 200 after curing. To facilitate this, the UV foil 18 may be manufactured from a material that does not become permanently bonded to the coating 26 or coated with a material that prevents the UV foil 18 from permanently bonding tot the coating 26. In some applications, it may be desirable to use a winch cable or other similar lead line to assist in moving the UV light source 22 (or other components, such as the camera) through the UV foil 18. For example, in the illustration of FIG. 7, the UV light source 22 is traversed through coated pipeline within the pressurized UV foil 18 with the assistance of a winch cable 19 that extends out the downstream end 204 of the pipeline section 200. The UV foil 18 may include a rubberized grommet (not shown) or other similar component to accommodate passage of the winch cable 19 through the UV foil's termination. Overcoming air passage is accomplished by CFM differential.

The UV foil inversion system 20 of the illustrated embodiment is a generally convention CIPP air inversion system. A variety of suitable inversion systems are commercially available. For example, inversion guns from Perma-Liner, CIPP Services, or an array of other suppliers may be incorporated into the present invention. In the illustrated embodiment, the UV foil inversion system 20 may include a conventional air inverter shooter/gun 82. The air inverter shooter 82 may include a UV foil inlet 84 for delivering UV foil 18 into the shooter, a manifold portion 86 and UV foil outlet 88 for introducing the UV foil 18 into the UV foil inversion tube 30. The UV foil outlet 88 is coupled to the free end of the UV foil inversion tube 30. The manifold portion 86 is coupled to a source of pressurized air (such as an air compressor 90) so that pressurized air can be supplied to the manifold portion 86 to invert the UV foil 18. The UV foil inversion system 20 may also include a UV foil take-up reel 92 that stores the UV foil 18 on a reel prior to inversion and feeds the UV foil 18 into air inverter shooter 82 during the inversion process. The reel 92 may be free spinning so that the introduction of air into the manifold portion 86 automatically and progressively feeds UV foil 18 from the reel 92 to the interior of the pipeline section 200. Air inverter shooter 82 and reel 92 are merely exemplary and may be replaced by essentially any equipment capable of inverting the UV foil 18 into the pipeline section 200.

In some applications, the coating system 10 may include a vacuum system 94 to draw a partial vacuum on the downstream end of the pipeline section 200. The vacuum system 94 may include essentially any vacuum source. For example, the vacuum source may be a generally conventional air compressor 94 that is coupled to vacuum inlet 70 and is configured to withdraw air from the downstream end 204 of the pipeline section 200 (See FIG. 9).

The coating delivery system 16 may be essentially any coating delivery system capable of distributing the coating 26 on the interior of the pipeline section 200 with sufficient uniformity for the action of the pressurized UV foil 18 to yield a uniform and void free coating. A variety of suitable coating delivery systems are commercially available. For example, the CoverCat spray system by Covercat or Spin-Kote units from Clemco may be incorporated into the present invention. In the illustrated embodiment, the coating delivery system 16 is a generally conventional spin-cast delivery system configured for internal pipeline use. The spin-cast delivery system 16 includes delivery head 80 that is movable through the interior of the pipeline section 200 (See FIG. 4). The delivery head 80 may be moved from the interior of the pipeline section 200 manually or through the use of automation, such as a trolley 81 (motorized or manually moved). The spin-cast delivery system 16 is merely exemplary and the present invention may include essentially any coating delivery system capable of adequately distributing coating over the interior of the pipeline section 200.

The present invention may be used to apply a wide range of coatings. In the illustrated embodiment, the coating 26 is a UV-cured epoxy with physical and chemical properties selected to achieve the desired functional purpose on the interior of the pipeline section 200 and to make the coating 26 appropriate for spin-cast delivery. The epoxy may include a UV catalyst that catalyzes curing when subjected to an adequate amount of UV light and/or a UV inhibitor that retards curing until the UV inhibitor is deactivated by an adequate amount of UV light. Although the described coating 26 is an epoxy, the coating system 10 may be used to apply other types of coatings. For example, the present invention may be used to apply urethane coatings, such as UV-curable polyurethane acrylates.

The UV light source 22 is generally configured to travel through the interior of the pipeline section 200 and the interior of the UV foil 18, and to emit sufficient UV light to cure the coating 26 while the coating 26 is suspended by the UV foil 18. The UV light source 22 may be include essentially any UV light source capable of producing sufficient UV light to transmit through the UV foil 18 and cure the suspended coating 26. A variety of suitable UV light sources are commercially available. For example, the UV light source 22 may a plurality of UV light emitting diodes (“LEDs”) arranged to form a light train. The number and type of UV LEDs incorporated into the UV light source 22 may vary from application to application depending on the UV transparency of the UV foil 18 and the UV-curing properties of the coating 26. In use, the UV light source 22 may be moved through the interior of the pipeline section manually or using automation. For example, the UV light source 22 may be mounted to a motorized trolley 96 that is capable of traveling through the interior of the pipeline section 200. A variety of suitable trolleys are commercially available. For example, the Anaconda by Aries Industries, Inc. or Power Light by IST, Inc. may be incorporated into the present invention. As an alternative to the use of a motorized trolley, the UV light source may be mounted to a pig or non-motorized trolley that can be manually moved through the interior of the pipeline section 200.

In some applications, the coating system 10 may include a camera system 24 configured to travel through the interior of the pipeline section 200. For example, the camera system 24 may be a conventional CCTV system with a camera 25 that transmits video/images to a display 27 that is located where it is readily visible to an operator. The camera 25 and display 27 may be coupled by wires/cord 29 or through the use of wireless communications. In the illustrated embodiment, the cord 29 is routed through the secondary access cap 40, which includes a compression cap 41 and a gasket 43 (e.g. rubber gasket) that provide a leaktight seal around the cord 29. In use, the secondary access cap 40 allows the cord 29 to feed into and out of inlet adapter 12 as the camera 25 travels through the pipeline section 200. The camera system 24 may be integrated into the light train trolley 96, carried by a dedicated camera trolley or provided without a trolley. When integrated into the trolley 96, the camera may be mounted ahead of the light source to allow visual inspection of the pipeline section prior to curing. A light shield (not shown) may be situated between the UV light source and the camera to confine the UV light to prevent premature curing of the coating 26.

In some application, the coating system 10 may include a pipeline reconditioning system to prepare the interior of the pipeline section 200 to receive the desired coating 26. For example, the pipeline reconditioning system may be configured to clean and profile the interior of the pipeline section 200. The pipeline reconditioning system may include one or more reconditioning heads selected to prepare the interior surface 206 of the pipeline section 200 as desired for proper adhesion of the coating 26. For example, the preconditioning head may be a pipeline pig configured to scape, brush or otherwise condition the interior surface 206. The preconditioning head(s) may have active elements configured to mechanically abrade or otherwise condition the interior surface of the pipeline, for example, high pressure fluid, sandblasting, wire brushes or other abrasive mechanisms.

C. Coating Method

As noted above, the present invention may be used to provide uniform and high quality coatings to the interior of pipeline sections, such as pipeline section 200. The coating system 10 discussed above may be used to implement a coating method that includes the following general steps: (a) applying a UV-curable coating 26 to inside of pipeline section 200, (b) installing the UV foil 18 in the interior 208 of the pipeline section 200, (c) pressurizing UV foil 18, (d) moving a UV light source 22 through the interior of the pressurized UV foil 18 to cure the coating 26 and (e) removing the UV foil 18 after the coating 26 is sufficiently cured. The method and variations options, including additional and alternative method steps, are described in the following paragraphs.

In the illustrated embodiment, the inlet adapter 12 and termination cap 14 are installed on opposite ends of the pipeline section 200. The inlet adapter 12 of this embodiment is fitted over the upstream end 202 of the pipeline section 200 and secured using any suitable structure, such as a compression fitting. The termination cap 14 of this embodiment is fitted over the downstream end 204 of the pipeline section 200 and secured using any suitable structure, such as a compression fitting. Although useful in providing an airtight enclosure when a vacuum will be applied to the downstream end 204 of the pipeline section 200, the termination cap 14 is optional and may be eliminated when not desired.

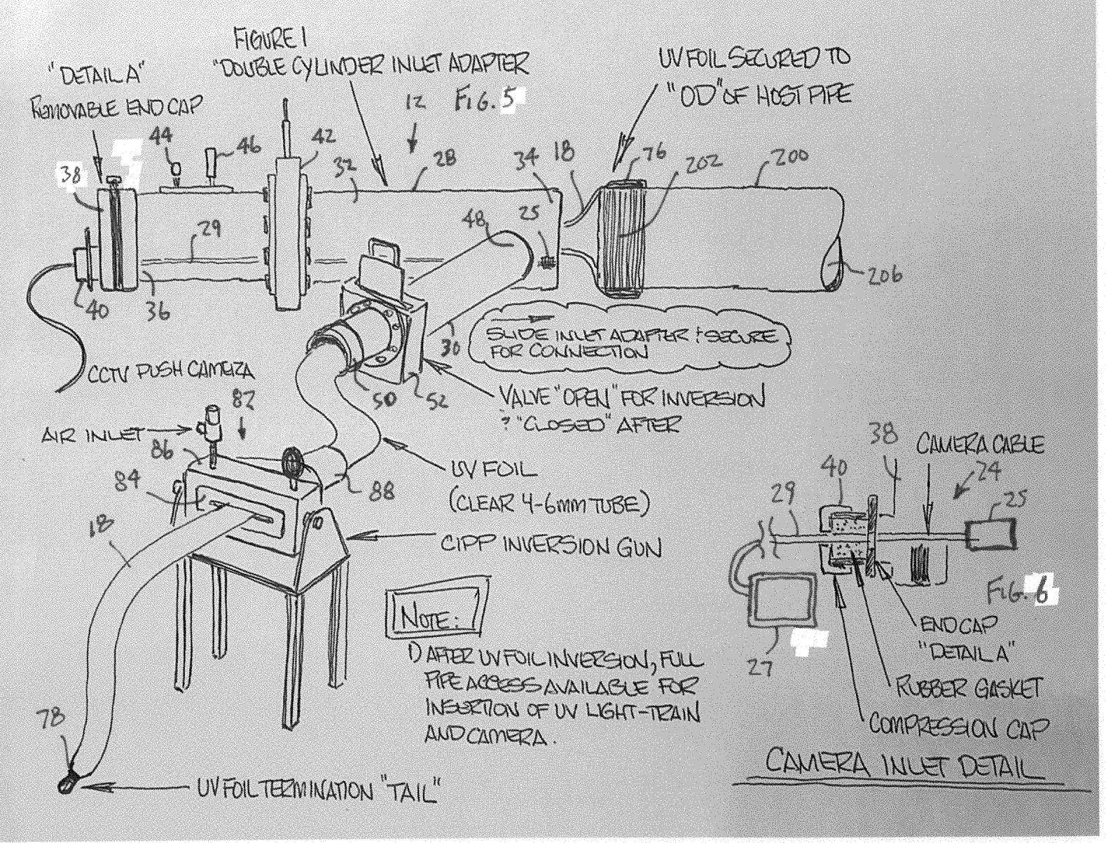

In the illustrated embodiment, the upstream end of the UV foil 18 is installed simultaneously with the inlet adapter 12. More specifically, in the illustrated embodiment, the open upstream end 76 of the UV foil 18 is fitted over the upstream end 202 of the host pipe, pipeline section 200 (See FIG. 5). The inlet adapter 12 is then fitted over the upstream end 202 of the host pipe (pipeline section 200) and the upstream end of the UV foil 18. The inlet adapter 12 is then secured to the pipeline section 200 by a compression fitting or other similar structure. Installing the compression fitting not only secures inlet adapter 12, but also clamps the upstream end of the UV foil 18.

The gate valves 42, 52 and 68 may be used to assist in carrying out different method steps. For example, gate valve 42 in the main tube 28 may be used to isolate the upstream portion of the main tube 28 from the interior of the pipeline section 200. When the gate valve 42 is closed, the primary and secondary access caps 38 and 40 can be opened without impacting air pressure within the pipeline section 200. In use, the gate valve 42 can be closed when introducing and removing components, such as the camera and/or the UV light source, into the main tube 28. If desired, the upstream portion of the main tube 28 can be re-pressurized to correspond with internal pressure before re-opening the gate valve 42. For example, pressurized air may be introduced into the upstream portion via air inlet 44 under pressure gauge 46 corresponds with pressure gauge 54. Similarly, the gate valve 68 in the termination cap 14 may be used to isolate the downstream portion of the termination cap 14 from the interior of the pipeline section 200. In use, the gate valve 68 can be closed when introducing and removing components, such as the spin-cast delivery head, into the termination cap 14. As with gate valve 42, the downstream portion of the termination cap 14 can be subjected to a partial vacuum that corresponds with internal vacuum pressure before re-opening the gate valve 68. For example, pressurized air may be introduced into the downstream portion via a second air/vacuum inlet 71 (shown in broken lines in FIG. 9) disposed in the downstream portion of the termination cap 14 until pressure gauge 72 corresponds with pressure gauge 74. Further, the gate valve 52 in the UV foil inversion tube 30 may be used to close off the UV foil inversion tube 30 after the UV foil 18 has been inverted in the pipeline section 200.

In some applications, it may be desired to inspect the interior 208 of the pipeline section 200 at different stages. For example, it may be desirable to pre-inspect the interior surface 206 of the pipeline section 200 to assess the potential for adequately applying the desired coating 26. In such applications, the camera of the camera system 24 may be moved through the interior 208 from one end of the pipeline section 200 to the other. This step may be performed before or after the inlet adapter 12 and/or termination cap 14 have been installed. In one embodiment, the camera is inserted into the main tube 28 of the inlet adapter 12. For example, the primary access cap 38 or the secondary access cap 40 may be removed and the camera may be inserted into the interior of the main tube 28. In applications that involve a wired/corded connection between the camera and the display, the wires/cords may be fitted through the secondary access cap 40, which include a grommet or other generally leaktight structure through which the wires/cords may pass into the interior of the main tube 28. As noted above, the camera system 24 may be used to inspect the interior of the pipeline section 200 at essentially any time, such as prior to any other activity, after or during pipeline preconditioning, after or during coating, before curing, during curing, after curing and after removal of the UV foil 18. When the inlet adapter 12 is installed, the camera may be introduced via the main tube 28 as discussed above. When the inlet adapter 12 is not installed, the camera may be introduced through the open upstream end 202 of the pipeline section 200. The camera need not, however, be introduce through the upstream end at all times. For example, when the UV foil 18 is not in place, the camera may be introduced through the downstream end 204. When termination cap 14 is in place, the camera may be introduced through the termination access cap 66. When the termination cap 14 is not installed, the camera may be fed into the open downstream end 204 of the pipeline section.

In the illustrated embodiment, the method may include the optional step of preparing the pipeline section 200 for coating. This may involve, for example, cleaning and profiling the interior surface 206 of the pipeline section 200. In this embodiment, the step may include the use of one or more preconditioning heads that are configured to travel through the interior 208 of the pipeline section 200. The preconditioning head(s) may be moved manually or through automation along the interior of the pipeline section 200. The coating system 10 may incorporate essentially any preconditioning equipment capable of providing the desired pipeline preconditioning. A variety of commercially available preconditioning equipment can be readily incorporated into the present invention. For example, the preconditioning head(s) may be one or more pipeline pigs configured to scape, brush or otherwise condition the interior surface of the pipe. If some applications, the preconditioning head(s) may have active elements that are driven to mechanically abrade or otherwise condition the interior surface of the pipeline. For example, the preconditioning head(s) may expel a high pressure fluid (e.g. air or water). The fluid may include an abrasive media, such as sand for sandblasting. As another example, the preconditioning head(s) may include a wire brush or other abrasive mechanical components that are spun or otherwise motivated to clean and/or profile the interior surface 206. As noted above, the camera system 24 may be use to inspect the pipeline section 200 to determine the appropriate preconditioning apparatus and after preconditioning to ensure that the internal surface 206 is prepared to receive coating 26.

As noted above, the present invention includes the step of applying the coating 26 to the interior surface 206 of the pipeline section 200. In the illustrated embodiment, the coating 26 is applied by a coating delivery system 16 that is capable of moving through the interior of the pipeline section 200. Although the coating delivery system 16 may vary from application to application, the coating delivery system 16 of the illustrated embodiment is a generally conventional spin-cast delivery system having a delivery head 80 that is movable through the interior of the pipeline section 200. The delivery head 80 may be moved from the interior of the pipeline section 200 manually or through the use of automation, such as a powered trolley (not shown). In use, the delivery head 80 is introduced into the pipeline section 200 through the downstream end 204. To prepare for coating, the delivery head 80 is moved through the interior of the pipeline section 200 to a position at or near the upstream end 202. For example, the delivery head 80 may be moved to a point slightly downstream from the upstream end 202. The delivery head 80 is then activated and the delivery head 80 is moved at a constant speed from the upstream end 202 to the downstream end 204. The speed of movement of the delivery head 80 is selected so that an appropriate layer of the coating is applied uniformly over the interior surface 206. In applications involving alternative coating systems, the coating delivery step may be varied as appropriate for the alternative coating system. The coating delivery head 80 may alternatively be introduced and operated from the upstream end of the pipeline section 200. As noted above, the present invention may be used to apply a broad range of coatings. In the illustrated embodiment, the coating 26 is an epoxy material. To prepare the epoxy material for coating delivery, the component parts of the epoxy material may be mixed just prior to use in the coating delivery process. The use of a UV-curable epoxy will help to prevent the coating 26 from curing before it is applied, distributed and held in suspension by the UV foil 18.

Following application of the coating 26, the present invention may optionally include one or more steps intended to assist in providing a uniform coat of the desired thickness over the entire interior surface 206. For example, the present invention may include the step of passing a pig or squeegee through the interior of the pipeline section 200 after the coating delivery step. A variety of commercially available pigs or squeegees are appropriate for use in distributing the applied coating 26. In use, the pig or squeegee may be introduced into the pipeline section 200 from the downstream end 204 and moved through the complete length of the pipeline section 200. In some application, a single pass may be appropriate and the pig or squeegee can be removed from the upstream end 202 of the pipeline 200. In other applications, the pig or squeegee may be moved through the pipeline section 200 in both directions before removal. In some applications, it may be desirable to pass two or more pigs or squeegees through the interior of the pipeline section 200 in series.

As discussed above, the UV foil 18 is inverted into the interior of the pipeline section 200 and pressurized to assist in distributing and suspending the coating 26 in a uniform and continuous layer along the interior surface 206. In the illustrated embodiment, the step of inverting the UV foil 18 into the pipeline section 200 includes the steps of: coupling the foil outlet 88 of the air inversion shooter 82 to the freed end of the UV foil inversion tube 30, feeding the UV foil 18 through the air inversion shooter 82 and supplying pressure to the manifold portion 86 of the shooter. Pressure is supplied to the shooter 82 until the full length of the UV foil 18 is fed through the shooter 82 and the UV foil 18 is fully inverted along the pipeline section 200. The UV foil 18 may be internally pressurized to the desired pressure by the shooter 82. As discussed above, the UV foil 18 may be pressurized with sufficient pressure to assist in distributing and suspending the coating 26 uniformly over the interior surface 26 of the pipeline section 200. In typical applications, the internal pressure of the UV foil 18 may be in the range of 3-10 psi, but the internal pressure may be outside this range in some applications. Once internally pressurized, the gate valve 52 can be closed to prevent pressurized air from escaping out the UV foil inversion tube 30. At this point, the free end of the UV foil 18 is held around the upstream end 202 of the pipeline section 200 opening toward the main tube 28 of inlet adapter 14. The pressure gauge 54 in the UV foil inversion tube 30 may be used to assist in bringing the interior of the UV foil 18 to the desired pressure. In some applications, the UV foil 18 may be elastic and may have a resting shape and size that is smaller (e.g. length and diameter) than the pipeline section 200. In these applications, the introduction of internal pressure may cause the UV foil 18 to expand in a manner akin to a balloon to fill the interior space 208 and coming into firm contact with the interior surface 206. In some applications, it may be desirable to visually inspect the interior of the pipeline section 200 using the camera system 24 before and/or after the UV foil 18 is inverted. Inspecting the pipeline before UV foil inversion may help to identify voids in the coating 26 that might be removed during UV foil 18 inversion. Inspecting the pipeline after UV foil inversion may help to identify defects into the coating application prior to the curing step while they can still be addressed.

In the illustrated embodiment, the method includes the step of applying a vacuum (e.g. partial vacuum) to the pipeline section 200 between the exterior of the UV foil 18 and the interior wall 206. The primary goal of the vacuum is to remove air from between the UV foil 18 and the interior wall 206 to assist in eliminating voids in the coating 26 and uniformly distributing the coating 26. Although the vacuum may be applied in essentially any suitable manner, the step is achieved in the illustrated embodiment by introducing a vacuum at the downstream end 204 of the pipeline section 200. The vacuum may be introduced through the termination cap 14 positioned on the downstream end 204. More specifically, a vacuum source may be coupled to air/vacuum inlet 70. The vacuum source may be engaged during the UV foil 18 inversion step, which may help in inverting the UV foil 18. Alternatively, it may not be engaged until after the UV foil 18 has been inverted and/or internally pressurized. The vacuum introduced to the system may vary from application to application depending in large part on the physical properties of the coating 26. In the illustrated embodiment, the vacuum may be in the range of −5 to −10 inches Hg, but the vacuum may be outside this range in some applications. In some applications, the vacuum may vary over time. For example, the vacuum applied during the UV foil inversion step may vary from the vacuum applied following that step. The pressure gauges 72 and 74 may be used to achieve and maintain the desired vacuum through the desired portions of the coating method. In some applications, internal pressurization of the UV foil 18 may be sufficient to provide acceptable results. In such applications, this vacuum step may be eliminated.

Once the UV foil 18 has been inverted and properly pressurized (and any desired vacuum is drawn on the downstream end of the pipeline section 200), the UV light source 22 may be moved through the interior 208 of the pipeline section 200 to cure the coating 26. As noted above, the camera system 24 can be moved through the interior of the pipeline section 200 to allow the operator to visually inspect the coating 26 as it is held in suspension by the UV foil 18. In some applications, it may be possible to eliminate any voids or other inconsistencies in the coating 26 by increasing the internal pressure or the external vacuum. The UV light source 22 is then moved through the interior of the pipeline section 200. The speed of motion of the UV light source 22 is selected so that the coating 26 receives sufficient UV light to render the UV inhibitor non-functional, thereby allowing the coating 26 to rapidly cure. In the illustrated embodiment, the UV light source 22 is carried by a motorized trolley 96. Motion of the trolley 96 may be automated so that the UV light source 22 travels at the appropriate speed along the full length of the interior of the pipeline section 200.

Following curing, the method may include the step of removing the UV foil 18 form the interior of the pipeline section 200. The UV foil 18 may be removed using a variety of alternative steps. However, in the illustrated embodiment, the UV foil 18 is removed by releasing the internal pressure on the UV foil 18, for example, by opening the gate valve 52 in the UV foil inversion tube 30 and/or an access cap 38 or 40 (with gate valve 42 open) in the main tube 28, and releasing any vacuum that may be applied to the downstream end, for example, by opening the access cap 66 in termination cap 14 with the gate valve 68 open. The inlet adapter 12 is removed to release the open end of the UV foil 18 after which the UV foil 18 can be removed from the pipeline section 200 through either the upstream end 202 or the downstream end 204.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A coating system for applying a coating to an interior of a pipeline section comprising:
a coating delivery system capable of delivering a UV-curable coating over at least a portion of the interior of the pipeline section, said coating delivery system being movable through the interior of the pipeline section;
a UV foil capable of being installed in the interior of the pipeline, said UV foil being flexible and being UV light transmissive;
a pressure supply operatively associated with said UV foil, said pressure supply configured to internally pressurize said UV foil within the interior of the pipeline section after a coating is applied, said internal pressure being sufficient to suspend the coating on an interior wall of the pipeline section; and
a UV light source movable through the interior of the pipeline and an interior of said UV foil, said UV light source capable of subjecting the coating to UV light of sufficient intensity to pass through said UV foil to assist in curing the coating.

2. The coating system of claim 1 wherein said UV foil is configured so that it is removable from the pipeline section after the coating is cured.

3. The coating system of claim 2 further including an inlet adapter having a first end configured to be fitted over a first end of the pipeline section, the inlet adapter having a first tube for introducing said UV foil into the interior of the pipeline section and a second tube for introducing the UV light source into the tube, said first tube and said second tube being in communication with said first end.

4. The coating system of claim 3 further including a UV foil introduction system coupled to said first tube, said UV foil introduction system configured to introduce the UV foil into the interior of the pipeline section through the first tube.

5. The coating system of claim 4 wherein said first tube includes an access cap and a valve.

6. The coating system of claim 5 wherein said second tube includes a valve.

7. The coating system of claim 3 wherein said UV foil has an open end, said open end fitted over the first end of the pipeline section between said inlet adapter and the first end of the pipeline section.

8. The coating system of claim 1 further including a vacuum system configured to be coupled to a second end of the pipeline section, said vacuum system capable of drawing a partial vacuum within the interior of the pipeline section.

9. The coating system of claim 8 further includes a termination cap configured to be fitted to the second end of the pipeline section, said termination cap having a vacuum inlet.

10. A method for coating an interior surface of a pipeline section, comprising the steps of:
applying a UV-curable coating to the interior surface of the pipeline section using a coating delivery system capable of moving through an interior of the pipeline section;
introducing a UV foil to an interior of the pipeline section;
internally pressurizing the UV foil with sufficient pressure to urge the UV foil into contact with the coating to suspend the coating for curing;
curing the coating by subjecting the coating to UV light with a UV light source movable through an interior of the UV foil; and
removing the UV foil from the pipeline section following said curing step.

11. The method of claim 10 including the step of applying a partial vacuum to the interior of the pipeline section external to the UV foil.

12. The method of claim 10 including the step of installing an inlet adapter on a first end of the pipeline section.

13. The method of claim 12 wherein the inlet adapter includes a first tube for introducing the UV foil into the interior of the pipeline section and a second tube for introducing the UV light source into the tube, the first tube and the second tube being in communication with the first end of the inlet adapter.

14. The method of claim 13 wherein the first tube includes a valve and an air inlet.

15. The method of claim 14 wherein the second tube includes a valve.

16. The method of claim 15 wherein the first tube and the second tube each include a pressure gauge.

17. The method of claim 11 wherein the UV foil has an open end and a closed end; and
further including the steps of:
positioning the open end of the UV foil over the first end of the pipeline section; and
installing an inlet adapter on a first end of the pipeline section over the open end of the UV foil to secure the UV foil.

18. The method of claim 1 further including the step of installing a termination cap on a second end of the pipeline section, the termination cap having a vacuum port.

19. The method of claim 18 wherein the termination cap has an access cap; and
further including the step of introducing the coating delivering system into the pipeline section through the access cap of the termination cap.

20. The method of claim 19 wherein the first tube has an access cap; and
further including the step of introducing the UV light source into the pipeline section through the access cap of the first tube.

21. A pipeline section fitted for coating comprising:
a pipeline section having a first end, a second end and an interior surface defining an interior;
an inlet adapter fitted to said first end of said pipeline section;
a UV-curable coating disposed along at least a portion of the interior surface of said pipeline section;
a UV foil having an open end and a closed end, said open end disposed over said open end, said UV foil disposed between said inlet adapter and said first end of said pipeline section, said UV foil extending through at least a portion of said pipeline section overlying said coating, said UV foil internally pressurized into engagement with said coating, said UV foil having sufficient internal pressure to suspend said coating; and
a UV light source configured to travel through said interior of said pipeline section within said UV foil, said UV light source capable of generating sufficient UV light to pass through said UV foil and assist in curing said coating on said interior surface.

22. The pipeline section of claim 21 further including a termination cap fitted to said second end of said pipeline section, said termination cap having a vacuum port through which a partial vacuum can be drawn at said second end of said pipeline section.

23. The pipeline section of claim 21 wherein said inlet adapter includes a mounted end mounted to said first end of said pipeline section, said inlet adapter having a first tube for introducing said UV foil into said interior of said pipeline section through said first end and a second tube for introducing said UV light source into said interior of said pipeline section through said first end.

24. The pipeline section of claim 23 wherein said first tube and said second tube each include a gate valve.
